(19) United States
(12) Patent Application Publication
(10) Pub. No.: US 2026/0275186 A1
(43) Pub. Date: Sep. 17, 2026

(54) WRAPAROUND DIRECT THERMAL LABEL

(71) Applicant: 13652611 CANADA INC., Laval (CA)

(72) Inventors: Gourgen AMBARTSOUMIAN, Laval (CA); Luciana DIESEL, Laval (CA); John WAGNER, Laval (CA)

(21) Appl. No.: 19/458,064

(22) Filed: Jan. 23, 2026

Related U.S. Application Data
(60) Provisional application No. 63/749,276, filed on Jan. 24, 2025.

(51) Int. Cl. C09K 9/02; C09D 11/03; C09J 7/20; G06K 19/07

(52) U.S. Cl. CPC C09K 9/02; C09D 11/03; C09J 7/203; G06K 19/0723; C09J 2203/334

(57) ABSTRACT

A wraparound label having a facestock having an upper surface and an undersurface, the facestock having a thermochromic ink and/or a thermochromic ink activation substance, so as to be configured to selectively darken or change color by heat activation when direct thermal printed. A layer of adhesive is on the undersurface of the facestock. A protective layer is on the upper surface of the facestock. A release layer is on the protective layer, whereby the protective layer is between the facestock and the release layer.

### CROSS-REFERENCE TO RELATED APPLICATION

The present application claims the benefit of U.S. Patent Application No. 63/749,276, filed on Jan. 24, 2025 and incorporated herein by reference.

### TECHNICAL FIELD

The present application relates to direct thermal printing and labels, for example in the context of the labelling of vial and containers.

### BACKGROUND OF THE ART

Direct thermal printing involves the heating of selected areas or zones of a coating on a substrate in order to heat activate a dye by reaction with a matrix. A print head (a.k.a., printhead) is controlled to heat the desired areas of the direct thermal coating by contact or close proximity and cause the reaction between dye and matrix, to blacken the areas that will define the printing on the label. Direct thermal packaging or label materials are usually made from a paper or thin thermoplastic facestock film material. A thermoplastic is a type of plastic made up of a polymer resin(s) that softens when heated and hardens when cooled. Thermoplastic films are commonly used as materials in label manufacturing and do not show any chemical property changes when heated or cooled multiple times.

In the bio pharmaceutical industry, it is often desired to use Peel-and-Reveal labels. Peel-and-Reveal labels are multi-layered labels, designed to provide additional space for information while maintaining a compact size, by having layers laid on one another. These labels are often used on containers, such as vials, bottles, syringes, or blister packs, where there is limited room to include all the necessary regulatory, usage, and safety information. The label in general consists of two or more layers of material that can be peeled back to reveal hidden information underneath a top one of the layers. The top layer typically includes primary details like the product name, dosage, batch number, etc. In most cases, the top layer is re-adherable, and the label design allows the label to be resealed after being peeled open, ensuring the information remains intact and protected. One of the challenges is that in many cases the Peel-and-Reveal labels are used in harsh environments. For example, it may be needed to apply Peel-and-Reveal labels to frozen containers or for deep-freeze and cryogenic applications. In many laboratories vaccines, antibodies, reagents, biological materials, samples are stored in freezers at −20° C., −40° C., −80° C., or below, etc. In cryogenic conditions, such as inside liquid nitrogen or other cryopgenic liquified gases and cryogenic freezers, temperatures may be as low as −196° C. or even below. Labels for these types of applications often comprise cryogenic and freezer grade adhesives which are aggressive and can damage the information on the layers underneath, in the case of Peel-and-Reveal labels. Therefore, there is a need for a Peel-and-Reveal labels that can function under those conditions.

Direct thermal printing is known to be cost effective, notably by not requiring a toner, a printer-applied ink or an inked ribbon in a printer, and thus printed by the relatively inexpensive printers used in direct thermal printing. However, areas printed with direct thermal may tend to fade over time when exposed to light, and may also be damaged by physical contact resulting from friction, wear and tear, frequent touching. As a result, direct thermal printing may not be optimal in some uses, such as for Peel-and-Reveal labels, or like wraparound labels coated with certain types of strong adhesives such as cryogenic adhesives or some permanent adhesives in which a label is wrapped onto itself and the adhesive contacts the ink or the printed surface of the facestock.

### SUMMARY

It is an aim of the present disclosure to provide a direct thermal label construction that addresses issues related to the prior art.

In one aspect, there is provided a wraparound label comprising: a facestock having an upper surface and an undersurface, the facestock having a thermochromic ink and/or a thermochromic ink activation substance, so as to be configured to selectively darken or change color by heat activation when printed by conductive contact; a layer of adhesive on the undersurface of the facestock; a protective layer on the upper surface of the facestock; and a release layer on the protective layer, whereby the protective layer is between the facestock and the release layer.

In another aspect, there is provided a wraparound label comprising: a facestock having an upper surface and an undersurface; a direct thermal coating layer on the upper surface or undersurface of the facestock, the direct thermal coating having a thermochromic ink and/or a thermochromic ink activation substance, so as to be configured to selectively darken or change color by heat activation when printed by conductive contact; a layer of adhesive, the direct thermal coating layer is between the facestock and the layer of adhesive; a protective layer on the upper surface of the facestock, the protective layer configured to shield the direct thermal coating layer; and a release layer on the protective layer, whereby the protective layer is between the facestock and the release layer.

In yet another aspect, there is provided a method for labelling a tube or vial comprising: printing a label having an exposed portion and a concealed portion, by conductive heat of a printer head toward the label; adhering an end of the concealed portion of the label onto the tube or vial; wrapping the label around the tube or vial to overlay the exposed portion of the label onto the concealed portion of the label adhered to the tube or vial, thereby concealing the concealed portion of the label with the exposed portion of the label.

In yet another aspect, there is provided a wraparound label comprising: a facestock having an upper surface and an undersurface; a thermochromic ink and/or a thermochromic ink activation substance in the facestock or a in direct thermal coating layer on the upper surface or undersurface of the facestock, so as to be configured to selectively darken or change color by heat activation when printed by conductive contact; a layer of adhesive on a side of the undersurface of the facestock; a protective layer on a side of the upper surface of the facestock; and a release layer on the protective layer, whereby the protective layer is between the facestock and the release layer.

### DESCRIPTION OF THE DRAWINGS

FIG. 1 is a schematic view of a vial or container configured to receive a wraparound direct thermal label in accordance with the present disclosure;

FIGS. 2A and 2B are schematic views of the direct thermal label in accordance with a variant of the present disclosure;

FIGS. 3A and 3B are schematic views of the direct thermal label in accordance with another variant of the present disclosure;

FIGS. 4A and 4B are schematic views of the direct thermal label in accordance with yet another variant of the present disclosure;

FIGS. 5A and 5B are schematic views of the direct thermal label in accordance with yet another variant of the present disclosure;

FIGS. 6A-6D are schematic views of the direct thermal label in accordance with the present disclosure, in a roll;

FIGS. 7A-7F are schematic views of the direct thermal label in accordance with the present disclosure, in a roll;

FIG. 8 is a method of unrolling the direct thermal label of the present disclosure from a wraparound condition; and

FIG. 9 is a schematic view of the direct thermal label of any of FIGS. 2A-7F.

### DETAILED DESCRIPTION

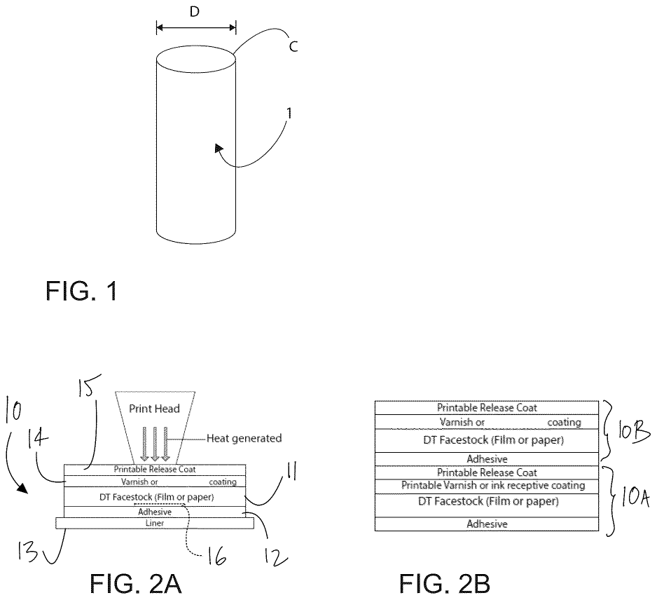

Referring to the drawings and more particularly to FIG. 1, an exemplary cylindrical portion of a sample tube or vial or bottle is illustrated at 1. Reference is made herein to the vial or tube as tube 1, even though item 1 may be a vial or any other type of container. For example, the tube 1 may be a blood collection tube, tube for collecting biological fluids or samples, microtube, a microcentrifuge tube, a matrix tube, a cryogenic vial, a PCR tube or microcentrifuge tube, a cryogenic in-vitro fertilization (IVF) straw such as one used in Artificial Reproductive Technologies (ART), a hollow cylindrical tubing such as blood transfusion tubing or similar, syringe, catheter, among other possibilities. The tube 1 is cylindrical in shape, with an outer diameter D ranging from a few millimeters to a few centimeters, though the tube 1 could be larger, and a circumference C expressed as being equal to TTD. While the expression “circumference” is used herein, C could be a value of periphery or perimeter, as the object 1 may not be a tube and/or may not have a circular cross-section. Accordingly, even if the expression “circumference” is used herein, C applies to non-circular and/or non-arcuate cross-sectional shapes. In an embodiment, the cylindrical surface of the tube 1 is made of a low surface energy (LSE) plastic, though the tube may consist of other materials, such as other types of plastics, polymers, copolymers or glass or composite materials comprising a mix of materials. Some examples of materials used in tube and vial manufacturing include Polyethylene Terephthalate (PET), Polypropylene (PP), Polystyrene (PS), Polyethylene (PE), Polycarbonate (PC), Polymethylpentene (PMP), Polyimide, Nylon, Teflon (PTFE-Polytetrafluoroethylene), Borosilicate Glass, Soda Lime Glass, metal or any derivatives, modifications or combinations thereof.

The tube 1 may be open ended so as to receive a sample(s) in its inner cavity. The tube 1 has a bottom face, circular in shape for example, and may have a shoulder between the bottom face and a cylindrical side surface thereof. In the illustrated embodiment, the outside diameter D of tube 1 may be of around 10 mm, though other diameters are contemplated. In a variant, the outside diameter ranges from 2 mm and 95 mm, inclusively. In another variant, the outside diameter ranges from 5 mm and 12 mm, inclusively. In another variant, the outside diameter ranges from 6.4 mm and 18 mm, inclusively. In another variant, the outside diameter ranges from 12 mm and 30 mm, inclusively. In another variant, the outside diameter ranges from 25 mm and 45 mm, inclusively. In another variant, the outside diameter ranges from 30 mm and 70 mm, inclusively. In yet another variant, the tube 1 is part of an IVF straw, and IVF straws are in general made from polymers or copolymers. IVF straws are used for freezing and storing substances such as sperm, eggs and embryos. Commonly used straws are approximately 0.25 ml and 0.5 ml in volume. In a variant, IVF straws have an internal diameter between 1.0 mm and 5.0 mm, inclusively, and more specifically between 1.2 mm and 3.0 mm, inclusively. Some straws may have shapes other than cylindrical shapes such as square, rectangular or possibly others, in which case the inner dimensions provided above may indicate the minimal distance between internal edges of the straw.

A height of the tube 1 may depend on the volume of the tube 1, and is usually between 10 mm and 200 mm without cap, though other heights outside this range are contemplated. In a variant the height of the tube 1 is between 10 mm and 35 mm without cap. In a variant the height of the tube 1 is between 28 mm and 50 mm without cap. In a variant the height of the tube 1 is between 45 mm and 125 mm without cap. In a variant the height of the tube 1 is between 100 mm and 155 mm without cap. In a variant the height of the tube 1 is between 115 mm and 200 mm without cap. In a variant, the volume of the tube 1 is between 0.2 ml and 20 ml, inclusively. In another variant, the volume of the tube 1 is between 0.5 ml and 6 ml, inclusively. In another variant the volume of the tube 1 is between 4 ml and 10 ml. In another variant, the volume of the tube 1 is between 6 ml and 15.0 ml, inclusively. In another variant, the volume of the tube 1 is between 10 ml and 30 ml, inclusively. In another variant, the volume of the tube 1 is between 20 ml and 50 ml, inclusively. In another variant, the volume of the tube 1 is between 25 ml and 100 ml, inclusively. In another variant, the volume of the tube 1 is between 50 ml and 250 ml, inclusively. In another variant, the volume of the tube 1 is between 100 ml and 500 ml, inclusively. The tube may have internal threading or external threading to receive a cap or may be friction seal type of a configuration for capping the tube (e.g., microcentrifuge tube). Other capping methods are contemplated. Tubes and caps can be sterile or non-sterile.

A cap may be sealingly received in the top open end of the tube 1, and may be hinged to the tube 1 as an option (including with an integral live hinge). In an embodiment, it can be said that the cap is an integral part of the tube 1 (i.e., when referring to “tube 1”, this may include the cap), but the cap may not be part of the tube 1, or it can be associated with the tube 1 through a plastic band, a living hinge or any other type of connector. The cap is typically made of an elastomer (including thermoplastic elastomers, rubber including silicone-coated rubbers) or plastic by which the cap is sealingly received and held captive while capping off the tube 1, for the sample in the tube 1 to be isolated from its environment by the cap. The cap may also be a screw cap, for threaded engagement with the tube 1, with appropriate threading (e.g. external or internal threading) being present in the tube 1 and on the cap. Other cap materials may be used, the elastomer being an example among others. The caps might have some other parts associated with it such as a swab or brush linked to the internal portion of the cap for the purpose of swabbing a sample from a patient. The tubes may have additive liners and/or coatings inside the tubes such as silicone, EDTA, sodium citrate, heparin, clot activators, gel separators, preservatives, stabilizers, specialty additives and other types of compounds depending on the intended use (e.g., anticoagulant or clotting agent).

Referring to the drawings and more particularly to FIG. 2A, a direct thermal label in accordance with a variant of the present disclosure is generally shown at 10. The direct thermal label 10 is shown adhered to itself in FIG. 2B, such as in a wraparound condition, with a release liner removed, with an underlayer 10A covered by an overlayer 10B. The expression “direct thermal” is used as a moniker to describe the nature of the label 10, i.e., a label that may be printed with direct thermal printers. Direct thermal printing uses chemically treated, heat-sensitive media that blackens or changes color when it passes under the thermal printhead, for instance by conduction. The label 10 may have a direct thermal facestock 11, an adhesive 12 on an undersurface of the direct thermal facestock 11 and optionally a support liner 13, in one possible embodiment. The label 10 may have on an upper surface of the direct thermal facestock 11 a varnish, top coat or like protective layer 14. A release coat or like adhesive release layer 15 may be on an upper surface of the protective layer 14. Optionally, a wireless communication component 16 such as an RFID (Radio Frequency Identification) or NFC (Near Field Communication), or Bluetooth that is capable of transmitting and/or receiving data or information may be incorporated underneath the facestock 11 or at other locations in the labels 10 described herein. The wireless communication component 16 may be provided in any of the labels 10 described herein, i.e., in any of FIGS. 2A-7F, even though not shown. Moreover, the wireless communication component 16 could be located at various other locations in the layered configuration of the labels 10 described herein.

The facestock 11 may be made of any appropriate materials, such as polymer, synthetic film, thermoplastic or thermoset film such as a polyethylene terephthalate (PET), polyolefin, polypropylene, oriented polypropylene, biaxially oriented polypropylene (BOPP), polyester, polyvinyl, acrylate polyethylene, High Density Polyethylene (HDPE), Low Density Polyethylene (LDPE), polystyrene, paper, impregnated paper, synthetic paper, silicone rubber, polyamide (nylon), polyimide, mineral-based synthetic film, stone paper, compostable, biodegradable films and similar polymer based materials, etc, non-woven fabrics, as well as any composite materials or any combination of materials comprising monomers or polymers or cellulose fibers, calcium carbonate, silica. According to an embodiment, the facestock 11 has thickness between 0.1 mil-30 mil, inclusively. According to another embodiment, the facestock 11 has a thickness between 0.4 mil-1.9 mil inclusively. According to another embodiment, the facestock 11 has a thickness between 0.5 mil-3.5 mil inclusively. According to another embodiment, the facestock 11 has a thickness between 1 mil-5 mil inclusively. The facestock 11 may be opaque, transparent, partially opaque, partially transparent, hazy, translucent, colored, destructible, tamper-evident. Instead of varnish or coating for the protective layer 14, it is possible to provide the label 10 with a thin lamination as protective layer 14, such as described in International (PCT) Patent Application No. PCT/IB2022/052848, incorporated hereby by reference. This thin lamination used as protective layer 14 would be under the release layer 14 with the DT layer being under the protective layer 14.

The facestock 11 may further include a thermochromic ink and/or a thermochromic ink activation substance. The facestock 11 is heat sensitive as it reacts to heat to darken or change the color. Zones or surfaces are selectively heated to darken by contact with the printhead, to constitute the printing on the label 10. According to an embodiment, a thermochromic ink of the facestock 11 is a leuco dye. These dyes have a colorless leuco form when crystalline in a PH neutral environment, and become colored when exposed to an acid which is called developer. The non-limitative examples of the most commonly used dyes are spirolactones, fluorans, spiropyrans, and fulgides. When in a heated state, the acid melts and the interaction between the acid and the dye causes the dye to change into its color form. Examples of acids suitable for thermochromic materials are octadecylphosphonic acid, phenols, e.g., Bisphenol A (BPA) and Bisphenol S (BPS). Other suitable acidic substances can be used as developers for leuco dyes (sulfonyl ureas, zinc salts of substituted salicylic acids, etc.). To optimize the colorization temperature and to facilitate mixing, sensitizers can optionally be added to the facestock 11, such as 1,2-bis-(3-methylphenoxy)ethane or 2-benzyloxynapthalene. These ethers are solvents for leuco dyes and developers, and facilitate color formation at a specific temperature. To stabilize the color formed by the leuco dye, developer and sensitizer, a stabilizer may be added to the facestock 11 prior to application on the label 10. As a non-limitative example, stabilizers may be phenols that inhibit recrystallization of the dye and developer, thereby stabilizing the printed image. Most of the component are usually microencapsulated in a protective coating to protect the content from undesired effects caused by the components. Upon heating, the structure of the microcapsules disintegrates causing the reaction between the components resulting the darkening. The above described technology is presented as an example, and not all constituents thereof are required to be present in the facestock 11 in order to achieve a thermal printing. For example, the facestock 11 might be activated without a sensitizer or stabilizer or both. Different types of thermochromic inks and developers can be used. The above described label 10 can be used with other types of thermochromic inks and is not limited to only the specific variants described. The facestock 11 may be transparent in its entirety or in the region of thermal printing, or have different degrees of opacity and transparency, for printing to be visible through the facestock 11.

The adhesive 12 in any of the variants described in the present disclosure may be any type of pressure sensitive or non-pressure sensitive adhesive including but not limited to water-based, hotmelt, UV hotmelt, LED UV curable hotmelt, rubber based, solvent based, acrylic based, emulsion, latex, silicone, radiation curable adhesives such as UV curable, LED UV curable, Electron Beam (EB) curable, heat-curable, Infrared curable, cross-linked or non-cross-linked adhesives, hot-stampable, cold-stampable, heat activated, etc. and any combination thereof. Permanent, ultra-permanent removable, ultra-removable, repositionable, biodegradable, biocompostable, or any other type of adhesives are contemplated. Optionally, the adhesive 12 may be resistant to cryogenic temperatures, may adhere to frozen surfaces, and/or may have a glass transition temperature (TG) of 0° C. or below, −20° C. or below, −40 C, −60° C. or below, −80° C. or below, −100° C. or below, −120° C. or below. Optionally, color may be in adhesive 12 for making it opaque. Optionally, the adhesive 12 may be glove friendly, resistant to high temperature, resistant to organic solvents, water, alcohols, lab conditions.

The expression label 10 is used for all variants described herein, and includes the various layers, coatings, etc described herein, and this includes the release liner (that may include an adhesive release layer on the support liner 13), even though the support liner 13 is removed and discarded when a remainder of the label 10 is adhered to an object (i.e., the liner 13 is absent from the label 10 on an object), or absent in instances in which the label 10 is provided in a roll without the support liner 13 a.k.a., linerless labels. The label 10, once removed from the release liner, may still be referred to as label 10, and can be also described as detached label 10, or detachable label 10. In another interpretation, it could be said that the release liner, if present (it is optional in all of the embodiments described herein), may not be part of the label 10. However, for consistency, the release liner will be described as being part of the label 10. Moreover, one release liner could be used with multiple separate removable label portions.

The support liner 13 (a.k.a., release liner) may be without an adhesive release layer, for example with the support liner 13 having a low adherence surface in contact with the adhesive 12. An adhesive release layer on the support liner 13 may be silicone based, non-silicone based, solvent-free, wax-based. The release liner, i.e., the support liner 13 and optionally the adhesive release layer on it can be made of any polymer based or paper based materials. Examples of polymer based film liners include thermoplastic films such as polyethylene terephthalate (PET), polyolefin, polypropylene, oriented polypropylene, biaxially oriented polypropylene (BOPP), polyester, polyvinyl, polyethylene, High Density Polyethylene (HDPE), Low Density Polyethylene (LDPE), polystyrene, synthetic paper, silicone rubber, nylon, polyamide, polyimide, mineral-based synthetic film, acrylate, compostable, biodegradable films and similar polymer based materials, as well as any composite materials or any combination thereof. The thickness of the polymer based support liner 13 can be between 0.5 mil and 12.0 mil. In another embodiment, the thickness of the polymer based support liner 13 can be between 0.8 mil and 2.0 mil. As another embodiment, the thickness of the polymer based support liner 13 can be between 0.9 mil and 1.8 mil. As another embodiment, the thickness of the polymer based support liner 13 can be between 1.1 mil and 1.6 mil. Paper based support liners 13 may include but are not limited to: Clay Coated Kraft paper, Super Calendered Kraft Paper, Glassines, Polyethylene Coated or Poly-Coated Kraft Papers such as LDPE, MDPE, HDPE coated Kraft Papers, etc. A number of release liners mentioned above are commercially available from Laufenberg GmbH (Krefeld-Hüls, Germany) and other companies. The thickness of a paper based support liner 13 can be between 1.0 mil and 12.0 mil. As an embodiment, the thickness of the paper based support liner 13 may be between 2.2 mil and 3.6 mil. As another embodiment, the thickness of the paper based support liner 13 can be between 2.0 mil and 2.6 mil. As another embodiment, the thickness of the paper based support liner 13 can be between 2.3 mil and 6.0 mil.

The varnish, top coat or like protective layer 14 over the facestock 11 may be provided to avoid direct contact between the printhead and the facestock 11 and to provide resistance to chemicals and solvents. There may nevertheless be conductive contact through the protective layer 14. Stated differently, the direct thermal label 10 described herein requires direct contact between a thermal print head and the label 10, and the thermochromic constituent of the label 10 will darken via heat conducted through other layers even if the thermochromic constituent is not directly in contact with the thermal print head. The protective layer 14 serves as a shield against direct contact with the facestock 11. The protective layer 14 may be water based, solvent based, UV curable, LED-UV curable, EB curable, heat-curable, infra-red curable, curable to any type of radiation, 100% solid topcoat, etc. As another variant, a thin lamination could be used as protective layer 14, such as described in International (PCT) Patent Application No. PCT/IB2022/052848, incorporated hereby by reference.

The release coat or like adhesive release layer 15 is on the upper surface of the protective layer 14. The adhesive release layer 15 is configured to exhibit low adherence, such that a pulling effort may suffice in detaching a portion of the label 10 adhered to itself in the manner shown in FIG. 2B. Optionally, the adhesive release layer 15 may exhibit lower adherence values than an adherence value of the adhesive 12 onto the object 1, such that pulling/detaching force applied to an end of the label 10 may suffice to detach the part of the label 10 overlaid onto itself, but may not suffice in detaching the label 10 from the object 1. The adhesive release layer 15 may be a coat. The adhesive release layer 15 may be UV curable, heat curable, EB-curable, IR curable, chemically curable. The adhesive release layer 15 may be non-silicone based or silicone based. The adhesive release layer 15 may be solvent-based or water-based or hot-melt. In a variant, the adhesive release layer 15 could be printable, i.e., it could receive ink thereon, in such a way that it will retain ink and will not smudge.

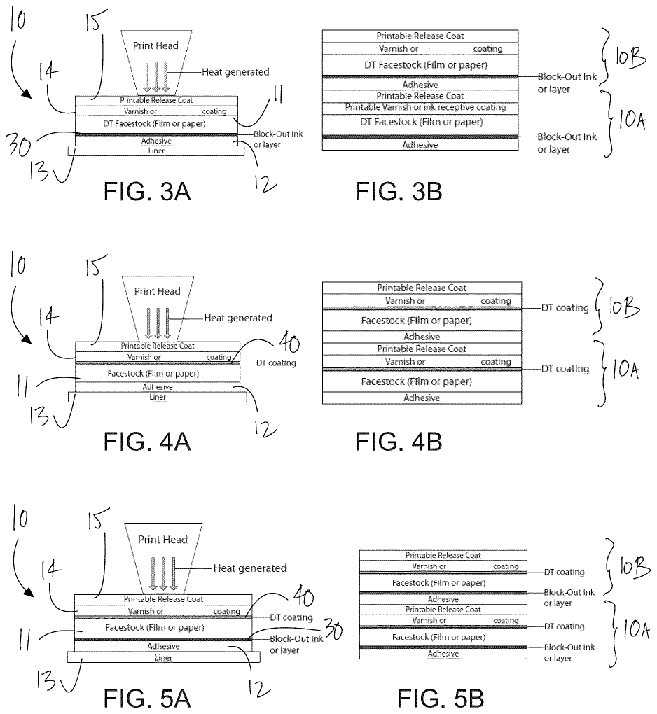

Referring to FIGS. 3A and 3B, an embodiment of the direct thermal label 10 similar to that of FIGS. 2A and 2B is illustrated, with like reference numerals illustrative of like elements. One difference is the presence of a block-out layer 30, such as between the facestock 11 and the adhesive 12. The block-out layer 30 may be an ink, a coating, a barrier layer, a polymer, etc, and is present to provide opaqueness to the direct thermal label 10, if the facestock 11 does not have opaque properties. Therefore, when the label 10 is wrapped onto itself, in the manner shown in FIG. 3B, any information inscribed onto an underlayer 10A of the label 10 will be concealed by the overlayer 10B. In the embodiment of FIGS. 2A and 2B, it is the facestock 11 that may provide the required opacity, if desired.

Referring to FIGS. 4A and 4B, an embodiment of the direct thermal label 10 similar to that of FIGS. 2A and 2B is illustrated, with like reference numerals illustrative of like elements. One difference is the presence of a direct thermal coating layer 40, i.e., the layer that provides the direct thermal printing functionality, instead of the facestock 11. The direct thermal coating layer 40 is the layer/portion of the label 10 with dye and matrix. For example, the direct thermal coating layer 40 includes a thermochromic ink and/or a thermochromic ink activation substance. The direct thermal coating layer 40 is heat sensitive as it reacts to heat to darken or change the color. The direct thermal coating layer 40 is shown as being on the upper face of the facestock 11, but could also be on the undersurface of the facestock 11 as described in PCT Patent application No. PCT/IB2022/052848. The direct thermal coating layer 40 is thus shielded by the protective layer 14, and optionally by the facestock 11. Zones or surfaces are selectively heated to darken by contact with the printhead, these zones contrasting with the color of the facestock 11 and constituting the printing on the label 10. According to an embodiment, a thermochromic ink of the layer 40 is a leuco dye. These dyes have a colorless leuco form when crystalline in a PH neutral environment, and become colored when exposed to an acid which is called developer. The non-limitative examples of the most commonly used dyes are spirolactones, fluorans, spiropyrans, and fulgides. When in a heated state, the acid melts and the interaction between the acid and the dye causes the dye to change into its color form. Examples of acids suitable for thermochromic materials are octadecylphosphonic acid, phenols, e.g., Bisphenol A (BPA) and Bisphenol S (BPS). Other suitable acidic substances can be used as developers for leuco dyes (sulfonyl ureas, zinc salts of substituted salicylic acids, etc.). To optimize the colorization temperature and to facilitate mixing, sensitizers can optionally be added to the direct thermal coating layer 40, such as 1,2-bis-(3-methylphenoxy)ethane or 2-benzyloxynapthalene. These ethers are solvents for leuco dyes and developers, and facilitate color formation at a specific temperature. To stabilize the color formed by the leuco dye, developer and sensitizer, a stabilizer may be added to the direct thermal coating layer 40 prior to application on the label 10. As a non-limitative example, stabilizers may be phenols that inhibit recrystallization of the dye and developer, thereby stabilizing the printed image. Most of the component are usually microencapsulated in a protective coating to protect the content from undesired effects caused by the components. Upon heating, the structure of the microcapsules disintegrates causing the reaction between the components resulting the darkening. The above described technology is presented as an example, and not all constituents thereof are required to be present in the direct thermal coating layer 40 in order to achieve a thermal printing. For example, the direct thermal coating layer 40 might be activated without a sensitizer or stabilizer or both. Different types of thermochromic inks and developers can be used. The above described label 10 can be used with other types of thermochromic inks and is not limited to only the specific variants described. The direct thermal coating layer 40 may be transparent, opaque, or translucent or may comprise a colorant or ink to have a colored background. It may include some adhesion promoter as part of the formulation. Other thermochromic inks can be used the same way for other applications.

If the direct thermal coating layer 40 is on the undersurface of the facestock 11 (contrary to FIG. 4A), the facestock 11 of the label 10 must have the capacity of conducting heat sufficiently, for heat from the print head A to activate the dye in the direct thermal coating layer 40. In an embodiment, this is achieved by having a given thickness for the facestock 11, that is small enough so as not impede substantially on heat conduction to the direct thermal coating layer 21A. According to an embodiment, the facestock 11 has thickness between 0.10 mil-0.30 mil, inclusively. According to another embodiment, the facestock 11 has a thickness between 0.10 mil-2.8 mil inclusively or between 2.5 and 72 microns, although it may also be thinner or thicker. Other ranges of values are contemplated. Direct thermal coating activation temperatures can affect the darkness of the print and its quality. In accordance with some variants of the present disclosure, when the print head A is at a temperature ranging from 50° C. to 300° C. resulted in suitable quality printing, for a thickness of the facestock 11 being within the ranges given above. As is common practice, printer settings may be adjusted to achieve different levels of darkness based on user preferences. In an embodiment, the activation temperature of direct thermal ink is between 50° C. and 300° C. In another embodiment, the activation temperature of the direct thermal ink is between 65° C. and 230° C. In another embodiment, the activation temperature of the direct thermal ink is between 75° C. and 180° C. In another embodiment, the activation temperature of the direct thermal ink is between 50° C. and 160° C.

Referring to FIGS. 5A and 5B, an embodiment of the direct thermal label 10 similar to that of FIGS. 4A and 4B is illustrated, with like reference numerals illustrative of like elements. One difference is the presence of the block-out layer 30, such as between the facestock 11 and the adhesive 12. Again, the block-out layer 30 may be an ink, a polymer, metallized layer, etc, and is present to provide opaqueness to the direct thermal label 10, if the facestock 11 and the direct thermal coating layer 40 do not have opaque properties. Therefore, when the label 10 is wrapped onto itself, in the manner shown in FIG. 5B, any information inscribed onto an underlayer 10A of the label 10 will be concealed by the overlayer 10B. In the embodiment of FIGS. 4A and 4B, it is the direct thermal coating layer 40 that may provide the required opacity, if desired. An example thereof is as described in U.S. Pat. No. 11,472,214, incorporated herein in its entirety.

The direct thermal printing in the direct thermal facestock 11 (FIGS. 2A-3B) or in the direct thermal coating layer 40 (FIGS. 4A-5B) may take any appropriate form, such as characters (letters, numbers, codes), symbols, ornaments, graphics, logos, codes (e.g., QR code, bar code), among other possibilities. The printing may be any type of information such as serialized numbers, serialized text, lettering, alphanumerical characters or serialized barcodes, random numbers, random barcodes, random alphanumeric data, random text or it may be non-variable information. The printing may be due to the release of leuco-dye. The label 10 may be printed in any appropriate way, including by dual print (thermal transfer and direct thermal), thermal transfer, direct thermal, LED printed, laser printer, electron beam printer. More particularly, because the release coating 15 is printable, i.e., it has the capacity to receive and retain ink, a dual printing of the label 10 may result in ink transferred onto the release coating 15 from a ribbon, via conductive contact (including direct contact). Moreover, the conductive heat from the printer head may activate the printing of the direct thermal coating or facestock. The facestock may have pre-printed information using any printing method including but not limited flexographic, digital, lithographic, laser, LED, inkjet, etc, on the surface or under the surface of any of the components of the label including liner, facestock, DT coating, protective coating, release coat.

Advantageously, the direct thermal facestock 11 (FIGS. 2A-3B) and the direct thermal coating layer 40 (FIGS. 4A-5B) are shielded by the protective layer 14, notably from the adhesive 12 of the overlayer 10B of label 10 when in a wraparound configuration. This may reduce the rate of fading of the printing, as the protective layer 14 shields the direct thermal facestock 11 (FIGS. 2A-3B) and the direct thermal coating layer 40 (FIGS. 4A-5B) from the adhesive, from air, solvents, alcohol, chemicals, oil, grease, light, UV rays, etc. Certain type of transparent polymer materials such as the ones comprising monomers and polymers of acrylate and methacrylate, polystyrene, or those comprising monomers, polymers, and UV absorbers have the capability of protecting against outdoor exposures such as sunlight and UV light and prevent discoloration or fading of the direct thermal printing.

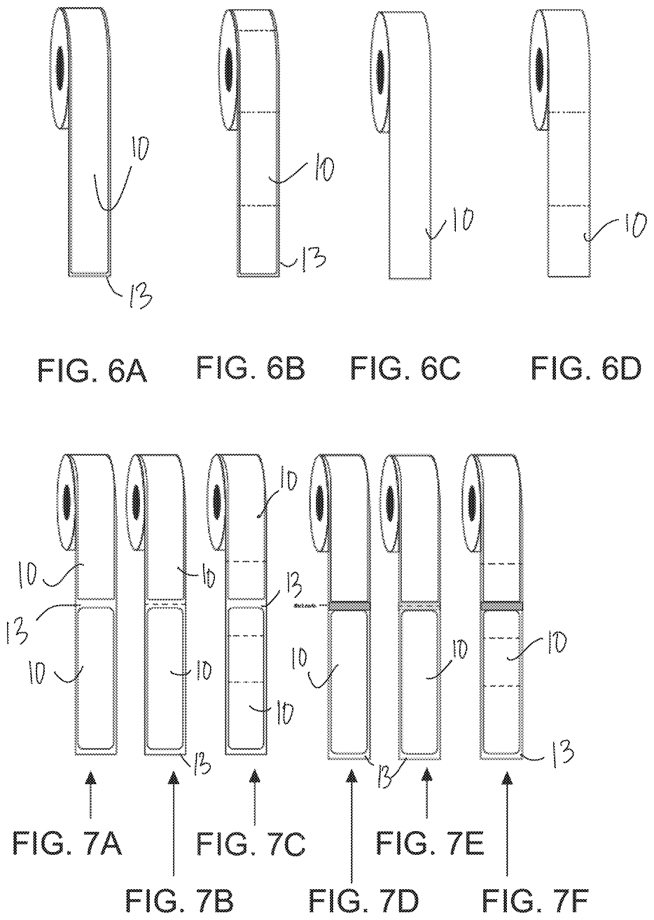

FIG. 6 shows the label 10 in different configurations, and may be for any of the embodiments of the label 10 described herein, with the label 10 being of continuous length. In (a) of FIG. 6, the label 10 is in a roll, with the support liner 13 being present, in a tape-like format. In (b) of FIG. 6, the label 10 is like in (a), but features tear-off perforations, that may or may not also be in the support liner 13. In (c) of FIG. 6, there is no support liner. In (d) of FIG. 6, the label 10 is like in (c), but features tear-off perforations.

FIG. 7 shows the label 10 in different configurations, and may be for any of the embodiments of the label 10 described herein, with the label 10 being a series of discrete labels 10. In (a) of FIG. 7, the labels 10 are on a common support liner 13. In (b) of FIG. 7, the labels 10 are like in (a), but tear-off perforations are in the support liner 13, located between adjacent labels 10. In (c) of FIG. 7, the labels are like in (b), but the tear-off perforations are not at the end of the label(s) 10, being located instead somewhere along the label 10, such that the separating of one of the label 10 with a portion of the support liner 13 from a remainder of the roll may have an end of the label 10 exposed. In an embodiment such as (c) in FIG. 7, additional perforations may be present in the support liner 13, between labels 10. This end of the label 10 without the support liner 13 may expose the adhesive 12, therefore facilitating adhesion of the end to a container, while the rest of the adhesive 12 is covered by the support liner 13. In (d), (e) and (f) of FIG. 7, the configurations of (a), (b) and (c) are replicated, but with marks to be detected by a printer. Other types of marks could also be present. Thus, the perforations described above may be used prior to applying to the vial or container, but may also allow separation of portions of labels to cut and transfer from vial to notebook, for example. In any of the embodiments described herein, the label 10 may have perforations or slits in the facestock 11.

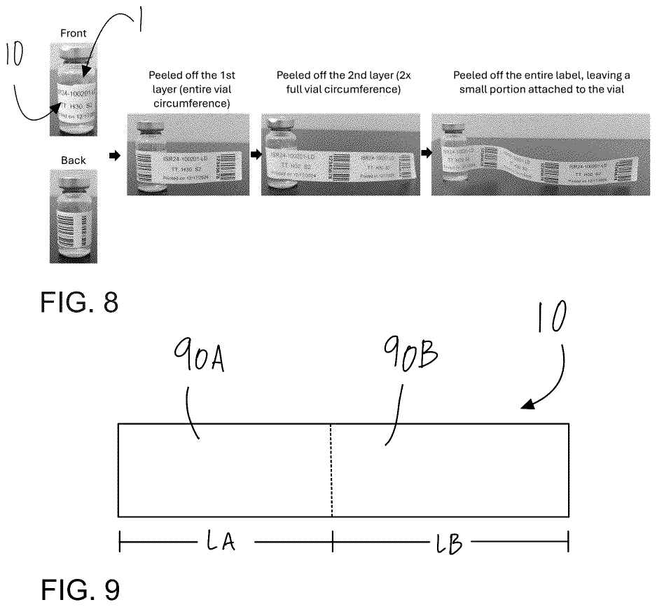

Referring to FIG. 8, when the label 10 is to be used with a tube 1 (the label 10 being any one of the labels 10 described herein), the label 10 may be selected by a user as a function of the outer diameter D, to achieve the coverage described above for FIG. 8, with at least a portion of overlap, resulting in at least two layers of the label 10 being superposed, as in FIGS. 2B, 3B, 4B and/or 5B. The length of the label 10 is of at least 1.1 C, but may be 2 C, 3 C, etc, to have suitable length to add information on the label 10. FIG. 8 shows the steps of unwrapping the label 10, to show information that is concealed by overlayers of the label 10. The presence of the release layer 15 allows the detaching, while the protective layer 14 protects the printing. Wrapping of the label 10 may be performed over an existing label. The label 10 may be pre-printed with data, images, graphics, barcode, or any combination thereof. The label 10 may be preapplied to a container, i.e., a pre-labelled container. The label 10 can be provided as part of a kit including one or more labels 10 and one or more containers 1.

Referring to FIG. 9, the direct thermal label 10 in accordance with the present disclosure, i.e., any of FIGS. 2A-7, is illustrated. The direct thermal label 10 is configured to be wrapped around an object, for some of the data on the label 10 to be concealed by a portion of the label 10 overlaid onto the data to be concealed. For reference, the object upon which the label 10 is wrapped is the tube 1 having circumference C, or like object having a periphery C. The label 10 has an exposed portion 90A and a concealed portion 90B. The exposed portion 90A is the portion of the label 10 that is visible (i.e., exposed) when the label 10 is completely wrapped around the object 1. The concealed portion 90B is the portion of the label 10 that is hidden when the label 10 is completely wrapped around the object, yet the concealed portion 90B can be exposed if desired, as explained below. In a variant, when wrapped around the object 1, the exposed portion 90A is overlaid onto the concealed portion 90B, in the manner shown in any of FIGS. 2B, 3B, 4B, 5B. The exposed portion 90A has a length LA, while the concealed portion has a length LB, with the label having a total length being LA+LB. An axis of wrapping is transverse to the lengths LA, LB. In a variant, LA is equal to C. LB may be less than C, may be equal to C, or may be greater than C. In a variant, the total length of the label 10 is at least 2 C, though it could be less.

The direct thermal label 10 may be used in a method for labelling a tube or vial, or any other object. The method may include printing a label 10 having an exposed portion 90A and a concealed portion 90B, by directly applying a printer head onto the label, or by other conductive contact heating of the label (e.g., thermal transfer), such as in FIGS. 2A, 3A, 4A and 5A; adhering an end of the concealed portion of the label onto the tube or vial; wrapping the label around the tube or vial to overlay the exposed portion of the label onto the concealed portion of the label adhered to the tube or vial, thereby concealing the concealed portion of the label with the exposed portion of the label. During the wrapping, the overlay may include adhering the exposed portion onto a release coat on a top surface of the concealed portion of the label. In accordance with the method, it may be required to remove a support liner from the label to expose an adhesive of the label, at least at the end of the concealed portion to begin with. When it is desired to display the concealed portion to expose the data, the method may include pulling an end of the exposed portion of the label to unwrap the exposed portion from the tube or vial to expose the concealed portion of the label.

The direct thermal label 10 can be applicable in any robotic, automation, printing, peeling and label and tape application devices (e.g., automation robotic device) and will cover any heat source beyond a printhead that is capable of activating the thermochromic and/or leuco-dye system. The described technology can be used in direct thermal printers as well as in thermal-transfer printers with or without an ink ribbon. In either case the activation of the dye will take place, although when ribbon is present, there may be ink transfer from ribbon to the surface of the release coat and the same information will be printed through the dye activation at the same location.

Another implementation of the direct thermal labels shown in the present disclosure may be in a piggy-back application. In another embodiment, a wireless communication element such as an RFID (Radio Frequency Identification) or NFC (Near Field Communication) or Bluetooth that is capable of transmitting and/or receiving data or information maybe incorporated underneath the facestock 11 or at other locations in the labels 10 described herein. The label 10 may or may not be sterile. Depending on the type of adhesive 12 used, the label 10 could be applied to frozen containers, including in cryogenic applications. In spite of the strength of the adhesives 12 required for such use, the DT printing is protected by the protective layer 14, and the release coating 15 allows the Peel-and-Reveal functionality. The release coat 15 may provide some additional protection beyond the protective coating 14.

The label technologies described in one or more of U.S. Pat. No. 11,319,464, U.S. patent application Ser. No. 17/092,719, U.S. patent application Ser. No. 18/060,778 are applicable to the label 10 described herein, and the content of these patents and patent applications is incorporated herein by reference.

1. A wraparound label comprising:
a facestock having an upper surface and an undersurface;
a thermochromic ink and/or a thermochromic ink activation substance in the facestock or a in direct thermal coating layer on the upper surface or undersurface of the facestock, so as to be configured to selectively darken or change color by heat activation when printed by conductive contact;
a layer of adhesive on a side of the undersurface of the facestock;
a protective layer on a side of the upper surface of the facestock; and
a release layer on the protective layer, whereby the protective layer is between the facestock and the release layer.

2. The label according to claim 1, wherein the thermochromic ink is a leuco dye.

3. The label according to claim 2, further including a stabilizer in the direct thermal coating to inhibit recrystallization of the leuco dye.

4. The label according to claim 3, wherein the stabilizer is a phenol.

5. The label according to claim 3, further including a sensitizer in the direct thermal coating to optimize the colorization temperature and to facilitate mixing.

6. The label according to claim 5, wherein the sensitizer is 1,2-bis-(3-methylphenoxy)ethane or 2-benzyloxynapthalene.

7. The label according to claim 1, wherein the facestock has a thickness between 0.10 mil and 2.8 mil, inclusively.

8. The label according to claim 1, wherein the facestock is made of a material selected from group of a thermoplastic film, a polymer, a synthetic film, acrylate, polyethylene terephthalate, polyolefin, polypropylene, oriented polypropylene, biaxially oriented polypropylene (BOPP), polyvinyl, polyethylene, polyamides, nylon, polyimide, or polystyrene.

9. The label according to claim 8, wherein the facestock is made of a thermoset material.

10. The label according claim 1, further including a wireless communication component.

11. The label according to claim 1, further comprising a release liner upon which the adhesive layer is releasably adhered.

12. The label according to claim 11, wherein the release liner includes an adhesive release layer and a support liner, the adhesive release layer being between the adhesive layer and the support liner.

13. The label according to claim 12, wherein the label has an adhesive configured to be adhered to a frozen container having a surface temperature of −20° C. or below, the label being peeled off from itself in wraparound arrangement without damaging the printed information underneath.

14. The label according to claim 1, wherein the label has an adhesive configured to be adhered to a frozen container having a surface temperature of −70° C. or below, the label being peeled off from itself in wraparound arrangement without damaging the printed information underneath.

15. The label according to claim 10, wherein wireless communication component is a RFID chip.

16. The label according to claim 1, wherein the label has an adhesive configured to be stored at temperatures between −70° C. and −196° C., the label being peeled off from itself in wraparound arrangement without damaging the printed information underneath.

17. A method for labelling a tube or vial comprising:
printing a label having an exposed portion and a concealed portion, by conductive heat of a printer head toward the label;
adhering an end of the concealed portion of the label onto the tube or vial;
wrapping the label around the tube or vial to overlay the exposed portion of the label onto the concealed portion of the label adhered to the tube or vial, thereby concealing the concealed portion of the label with the exposed portion of the label.

18. The method according to claim 17, further including removing a support liner from the label to expose an adhesive of the label.

19. The method according to claim 17, further including pulling an end of the exposed portion of the label to unwrap the exposed portion from the tube or vial to expose the concealed portion of the label.

20. The method according to claim 17, wherein the adhering and the wrapping are performed by an automated robotic device.
